(19) United States
(12) Patent Application Publication
(10) Pub. No.: US 2014/0051325 A1
(43) Pub. Date: Feb. 20, 2014

(54) TOY SYSTEM HAVING TWO PLAY STRUCTURES AND A FIGURINE

(71) Applicants: William M. Paukert, Pawtucket, RI (US); Dan Judkins, Providence, RI (US); Eric Listenberger, Portsmouth, RI (US); Hiroyuki Nagasu, Tokyo (JP)

(72) Inventors: William M. Paukert, Pawtucket, RI (US); Dan Judkins, Providence, RI (US); Eric Listenberger, Portsmouth, RI (US); Hiroyuki Nagasu, Tokyo (JP)

(21) Appl. No.: 13/588,200

(22) Filed: Aug. 17, 2012

(51) Int. Cl. A63H 17/26; A63H 3/36; B23P 11/00; A63H 33/00

(52) U.S. Cl. 446/297; 446/475; 446/268; 446/397; 446/376; 446/429; 29/428; 29/434

(57) ABSTRACT

A toy system having two toy vehicles and a figurine for enhanced play value. One toy vehicle is large, has three actuators and front and rear ramps. The first actuator causes the large vehicle to open its sides to form a playset. The second actuator is located on a risible ladder with a platform having a trap door floor and enables the figurine to drop from the platform to the small toy vehicle. The third actuator launches the small toy vehicle down the front ramp from a storage compartment in the large toy vehicle after the small toy vehicle had been loaded into the storage compartment by opening the rear ramp. The small vehicle is transformable between a vehicle configuration and a robot configuration.

### FIELD OF THE INVENTION

The present invention relates generally to a toy system having enhanced playing modes, and more particularly, to a toy system having two structures in the form of toy vehicles, and a figurine, where one toy vehicle has a storage compartment for the second toy vehicle, and the first toy vehicle has front and rear ramps for loading and launching the second toy vehicle, and a risible structure for dropping the figurine from the first toy vehicle to the second toy vehicle.

### BACKGROUND OF THE INVENTION

Toy vehicles have generally been a consistent play item for young boys because toy vehicles generally have very high play value. Propelling toy vehicles vary from having a child simply push the toy vehicle manually on a playing surface to devices using gravity, such as by placing flexible tracks at a high elevation. Devices for propelling toy vehicles have also included launching apparatus having springs and battery power.

Launching devices for toy vehicles are well known. For example, a 1961 U.S. Pat. No. 2,975,552 listing Bonanno as inventor, issued for an “Operating Brakeman” and purports to disclose a model railway car having a solenoid operated brakeman manikin that is adopted to pivot between erect and prone positions as the railway car approaches a tunnel or low overhang. A 1972 U.S. Pat. No. 3,693,282, listing Adicks as inventor issued for a “Toy Vehicle Launching Device With Safety Mechanism” and purports to disclose a mobile launching device with a spring operated piston. When the piston is cocked a safety bar prevents a launch button from releasing the piston. The safety bar is moved away when the device is firmly held against a surface so that when the launch button is pressed, a piston is released and the vehicle is launched.

In 1980, a U.S. Pat. No. 4,192,093, listing Hamano as inventor issued for a “Toy Carrier Vehicle” and purports to disclose an unpowered carrier vehicle like a truck with cargo space for a spring powered smaller toy vehicle like a car. When the carrier truck is pushed along a surface a wheel is engaged to a wheel of the car to wind the car's spring. When the car spring is wound a cargo ramp may be lowered and the car may be released from the cargo space to move away from the truck. Or, the ramp may remain latched and the car may be retained in the cargo space where its wheel will be rotated by the spring and provide power to the truck wheel. A 1987 U.S. Pat. No. 4,708,683, listing Lehmann and Satten as inventors issued for a “Toy Car Carrier” and purports to disclose a toy tractor-trailer where the trailer carries multiple toy cars. Pivotal side handles operate between raised and lowered positions. When in the raised position the handles provide a mechanism for carrying the toy tractor-trailer while confining the toy cars to the toy trailer. When the handles are lowered the toy cars may be removed from the toy trailer. In 1989, U.S. Pat. No. 4,889,515, listing Auer and Reina as inventors issued for a “Four-Wheel Drive Toy And Truck Assembly” and purports to disclose a non-motorized toy flat bed truck and a motorized car. The car has pinions connected to its front and rear axles, the front pinion being engagable with a movable ramp on the truck allowing the car to load itself unto the truck and retract the ramp. Thereafter, the car's rear pinion may used to drive the truck through a gear train to the truck's rear wheels.

A 2010 U.S. Pat. No. 7,857,679 B2, listing O'Connor and Nuttall as inventors issued for a “Toy Track Set And Relay Segments”, and in 2011, a U.S. Patent Application, No. 2011/0092132 A1, a continuation of the application for the U.S. Pat. No. 7,857,679, listing the same inventors and having the same title, was published, with both the patent and the application purporting to disclose a track system for toy vehicles having multiple “relay segments.” Each relay segment features a stunt activity where an incoming toy vehicle triggers an element of the relay segment to perform a stunt with the same or other toy vehicles. After the stunt, another toy vehicle exits the segment to move to the next relay segment to activate another trigger. One of the relay segments features a crane element which, after activation, lifts a toy vehicle between jaws and drops the toy vehicle on a trigger that causes a panel to flip a couple of toy vehicles and release still another vehicle to move to the next relay segment. Each relay segment is self-contained and may be combined by an operator in various combinations.

A published U.S. Patent Application, No. 2010/0330873 A1 for a “Toy Vehicle Launcher” published in 2010, and listing McCafferty et al., as inventors, purports to disclose a toy launcher with a removable toy vehicle cartridge, a track connector for such track as marketed under the HOT WHEELS brand, a spinning drive wheel, a string spool, a removable ramp, a string spool winder, a bipod, a detachable clamp, a vehicle receiving device and a toy vehicle having a flywheel. The launcher operates in different ways. The toy vehicle may be propelled by a rip-cord or by the spinning drive wheel. The toy vehicle may move along a track, a table, a floor or the string. The bipod may be used to stabilize the launcher or the launcher may be hand held. The toy vehicle may be dropped into the launcher or multiple vehicles may be introduced one at a time from the vehicle cartridge using a retractable handle. A 2011 U.S. Pat. No. 8,011,994, listing Fink et al., as inventors issued for a “Self-Assembling Toy, Toy Assembler, Launcher, And Track” and purports to disclose a toy vehicle assembly system using magnetic wheels and axles as the wheels and vehicle bodies are brought together in a device configured to house multiple toy vehicle bodies.

These disclosures are interesting, but none disclose a simply constructed but robust device that allows multiple play features in a two-toy vehicle and figurine system.

### SUMMARY OF THE INVENTION

In accordance with the present invention, a two-vehicle toy and figurine system is provided with enhanced play value in robust structures and yet each of the structures is simply constructed. The present invention also provides an advantageous method for manufacturing the two-vehicle toy and figurine system. A described preferred embodiment set forth below includes a large toy vehicle having a storage compartment, a small toy vehicle scaled to be received by the storage compartment, a latch to open the large toy vehicle, and reveal the small toy vehicle and a figurine movable between the large and small toy vehicles. The present invention provides excellent play value, is simply constructed with robust structures, is easy to use, and is relatively inexpensive.

Briefly summarized, the invention is a toy system having two play structures including a first toy structure having a storage compartment, front and rear ramps communicating with the storage compartment, and first and second sidewalls being movable along vertical axes between a closed position covering the storage compartment and an opened position exposing the storage compartment, and a second toy structure receivable in the storage compartment along the rear ramp to enable the second toy structure to be stored and transported in the storage compartment of the first toy structure when the first and second sidewalls are in the closed position and to be launched from the first toy structure along the front ramp when the first and second sidewalls are in the opened position.

The present invention also includes to a method for manufacturing a toy system with two toy vehicles including the steps of providing a first toy vehicle having a storage compartment and front and rear ramps, scaling a second toy vehicle to enable the second toy vehicle to be received and stored in the storage compartment of the first toy vehicle using the rear ramp and launched using the front ramp, dividing a portion of the first toy vehicle between two sidewalls, the sidewalls being movable between a closed position and an opened position, and mounting an actuator to the first toy vehicle to cause the side structures to move from the closed position to the opened position.

### BRIEF DESCRIPTION OF THE DRAWINGS

For the purpose of facilitating an understanding of the invention, the accompanying drawings and description illustrate preferred embodiments thereof, from which the invention, its structures, its construction and operation, its processes, and many related advantages may be readily understood and appreciated.

FIG. 1 is a side elevation view of a preferred embodiment of a toy system having toy structures including a large toy vehicle, a small toy vehicle and a figurine.

FIG. 2 is a side elevation view of the small toy vehicle shown in FIG. 1, entering a storage compartment of the large toy vehicle along a rear ramp.

FIG. 3 is a perspective view of the large toy vehicle shown in FIGS. 1 and 2 with the figurine in a driver's cabin of the large toy vehicle and sidewalls of the large toy vehicle in a closed position.

FIG. 4 is a front perspective view of the large toy vehicle shown in FIGS. 1-3, where the sidewalls are in an opened position exposing the small toy vehicle in the storage compartment.

FIG. 5 is an enlarged partial front perspective view of the large toy vehicle shown in FIG. 4 with a ladder in a raised position and the figurine located on a platform of the ladder.

FIG. 5A is a side perspective view of the large toy vehicle shown in FIG. 5 with the ladder in the raised position and the figurine located on the platform of the ladder just prior to an operator depressing an actuator to open a trap door of the ladder platform.

FIG. 6 is a partial front perspective view of the large toy vehicle, as shown in FIG. 5, with the ladder in the raised position and the figurine falling through the trap door of the platform of the ladder.

FIG. 7 is a partial front perspective view of the large toy vehicle, as shown in FIGS. 5 and 6, illustrating the figurine having fallen into a driver's cabin of the small toy vehicle.

FIG. 8 is a downward looking perspective view of a portion of the large toy vehicle and illustrating the small toy vehicles being launched along a front ramp of the large toy vehicle.

FIG. 9 is a side elevation view of the small toy vehicle shown in FIG. 1, turned 180°.

FIG. 10 is a side elevation view of the small toy vehicle illustrating the front portion of the small toy vehicle being rotated upward as the small toy vehicle is transformed to a robot.

FIG. 11 is a front elevation view of the robot after transformation is completed.

FIG. 12 is a side elevation of the robot shown in FIG. 11.

FIG. 13 is a side elevation view of the robot illustrating an upper portion of the robot being rotated downward as the robot is transformed to the small vehicle.

FIG. 14 is a front perspective view of the small toy vehicle after transformation is completed.

FIG. 15 is a flow diagram of a method for manufacturing the toy system shown in FIG. 1.

### DESCRIPTION OF THE PREFERRED EMBODIMENT

The following description is provided to enable those skilled in the art to make and use the described embodiment set forth in the best mode contemplated for carrying out the invention. Various modifications, equivalents, variations, and alternatives, however, will be readily apparent to those skilled in the art. Any and all such modifications, variations, equivalents, and alternatives are intended to fall within the spirit and scope of the present invention.

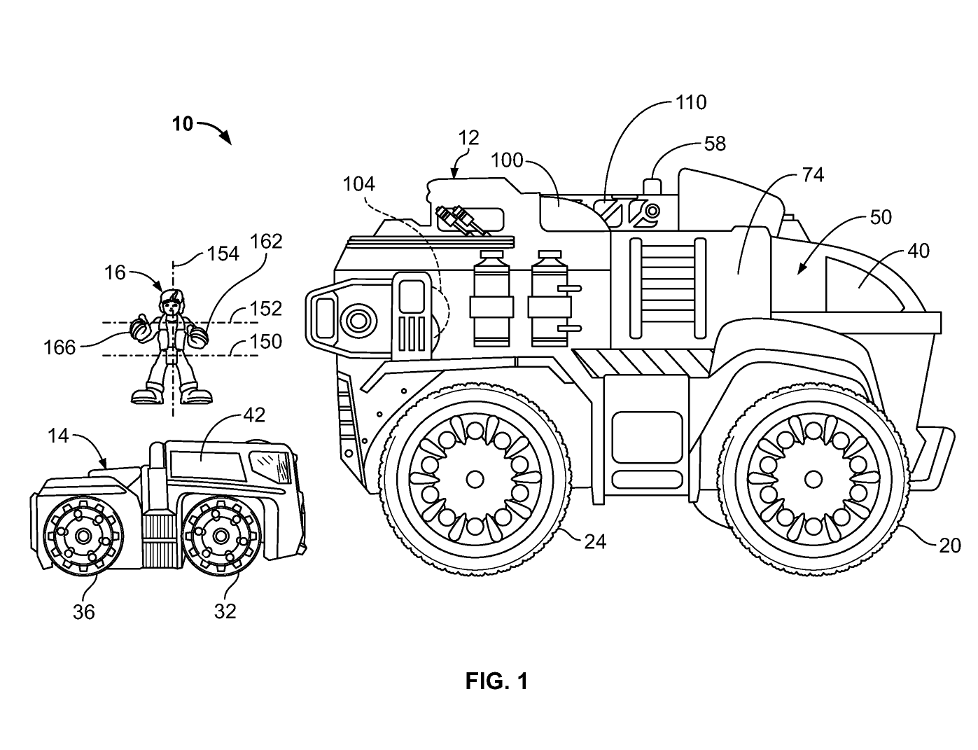

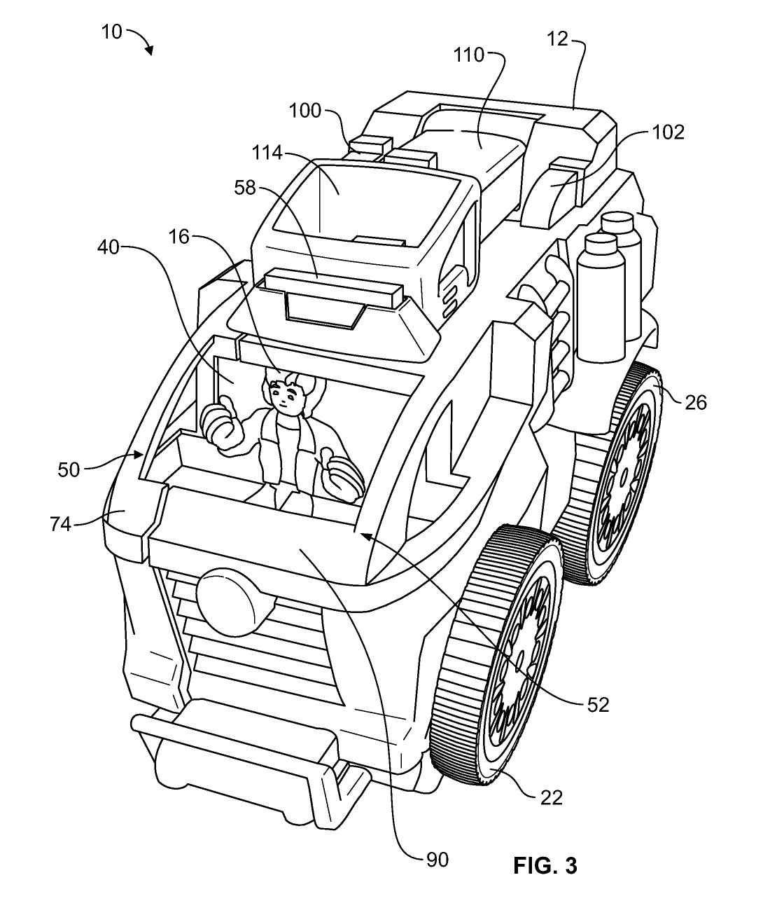

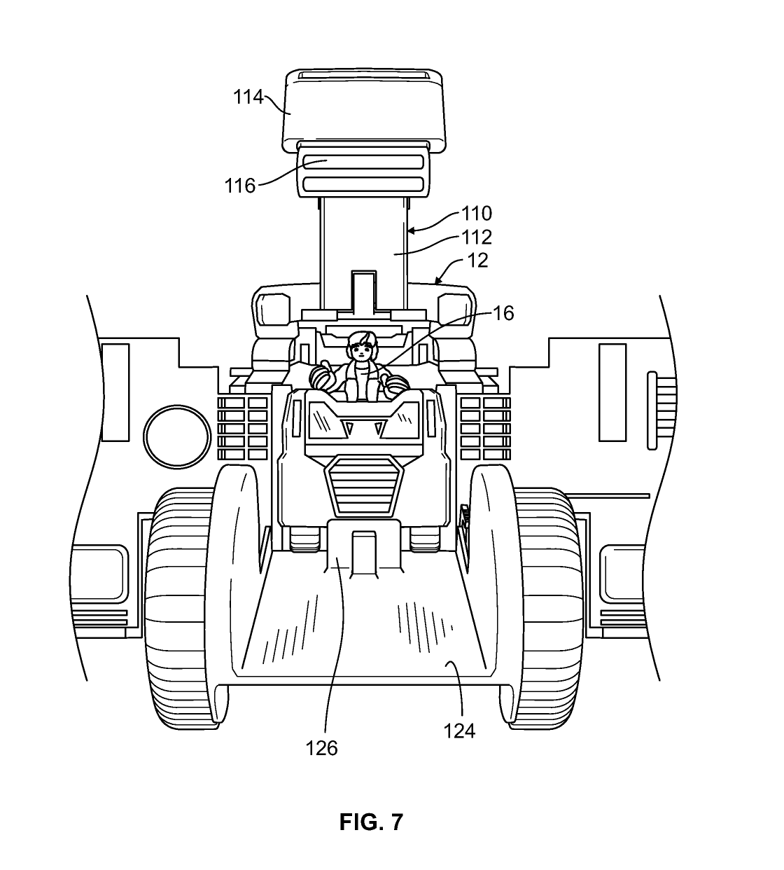

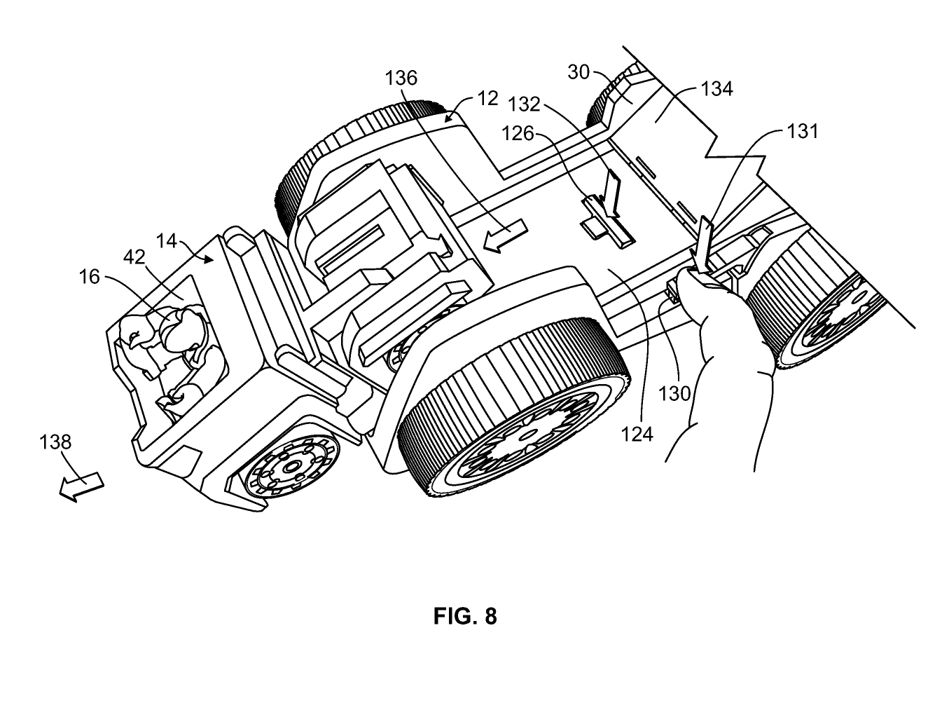

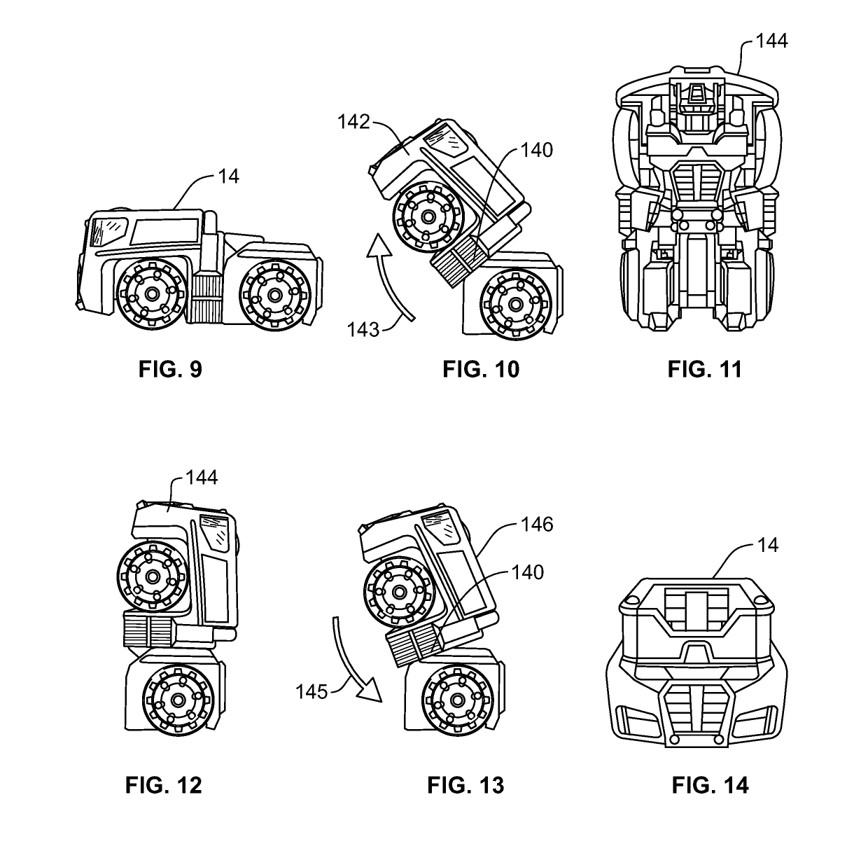

Referring now to FIGS. 1-4, there is illustrated a preferred embodiment of the present invention in the form of a toy system 10 having two main play structures, the first play structure in the form of a large toy vehicle 12 and the second play structure in the form of a small toy vehicle 14. In addition, the toy system may include a figurine 16. The large and small vehicles 12, 14 may take the form of RESCUE BOTS brand toys, the large vehicle 12 having four wheels 20, 22, 24, 26 and a futuristic fire engine or medical rescue vehicle design. The large vehicle 12 includes a storage and transport compartment 30 to store and transport the small vehicle 14. The small vehicle 14 also has four wheels 32, 34, 36, 38. The small vehicle 14 is constructed to enable a transformation from the vehicle configuration shown in FIG. 1, to a robot configuration and back from a robot configuration to the vehicle configuration as shown in FIGS. 9-14. The robot configuration has the appearance of a well-known TRANSFORMER brand robot known as OPTIMUS PRIME, also a brand of robot. The figurine 16 may take the form of a CODY BURNS brand figure scaled to allow placement in a driver's cabin 40, FIG. 3, in the large vehicle 12 and a driver's cabin 42, FIGS. 7 and 8, in the small vehicle 14.

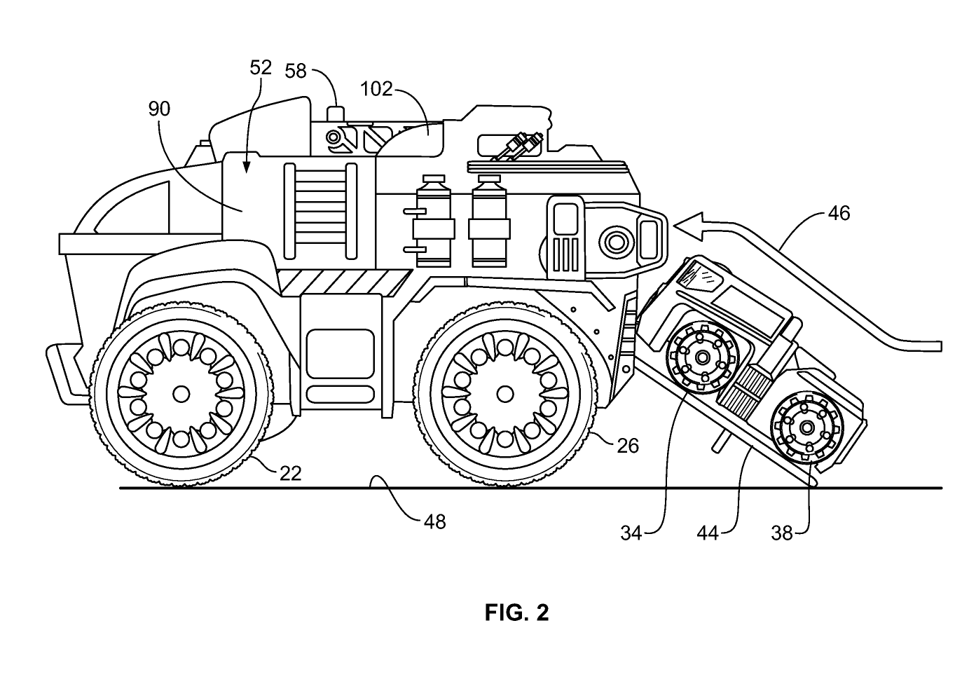

The large vehicle 12 includes a rear ramp 44, FIG. 2, opening to the storage compartment 30 that may be lowered by an operator of the toy system 10 to allow the small vehicle 14 to be rolled into and be received by the storage compartment as indicated by an arrow 46. Once the rear ramp 44 is closed the small vehicle 14 is generally hidden from view and is secured. The operator may carry the large and small vehicle combination together or more often, push the large vehicle 12 with the stored small vehicle 14 inside the compartment along a surface, such as a floor 48, FIG. 1, and thereby engage in one important mode of play.

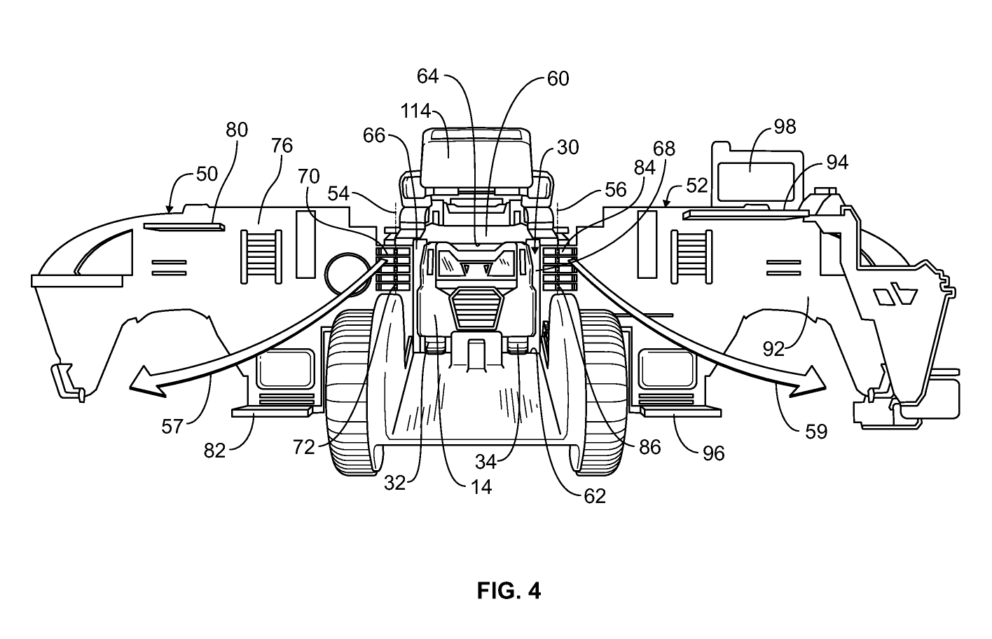

The large vehicle 12 includes first and second sidewalls 50, 52 that appear as the side panels and front portion of the large vehicle when the sidewalls are in a closed position, as shown in FIGS. 1-3, but are spring biased to rotate along vertical axes 54, 56, FIG. 4, when a first actuator 58, in the form of a latch and switch mounted to the top of the large vehicle 12, is depressed. Depressing the first actuator 58 enhances the play value of the toy apparatus by causing the sidewalls 50, 52 to move from the closed position, shown in FIGS. 1-3, to an opened position shown in FIGS. 4-7, and as indicated by arrows 57, 59, and thereby create another mode of play for the operator. Instead of pushing the large vehicle along a surface, the operator may manipulate items in a stationary playset.

The first or left sidewall 50, as viewed in FIG. 4, and the second or right sidewall 52 are connected to a central body portion 60 of the large vehicle 12. The central body portion 60 includes a floor 62, a ceiling 64 and two internal walls 66, 68 that help define the storage compartment 30. The left sidewall 50 is connected the central body portion 60 by a hinge 70 that includes a torsion spring 72 biasing the left side structure 50 to the opened position. An outer surface 74, FIG. 1, of the left sidewall 50 forms the left side and a small portion of the front of the large vehicle 12 when the sidewalls are in the closed position, as shown in FIG. 3, and an inner surface 76 of the left sidewall forms part of the playset when the sidewalls are in the opened position. For example, the playset inner surface of the left sidewall includes horizontal panels 80, 82, FIG. 4, that may function as shelves or seats.

The right sidewall 52 is connected to the central body portion 60 by a hinge 84 that includes a torsion spring 86 biasing the right sidewall to the opened position. An outer surface 90, FIG. 3, of the right sidewall forms the right side and most of the front portion of the large vehicle when the sidewalls 50, 52 are in the closed position, and a second or inner surface 92, FIG. 4, forms part of the playset when the sidewalls 50, 52 are in the opened position. For example, the playset or inner surface 92 of the right sidewall 52 includes horizontal panels 94, 96 that may also function as shelves or seats, and a pivotal panel 98 that may simulate a computer or television screen. The sidewalls 50, 52 rotate about 90° when moving from the closed position to the opened position.

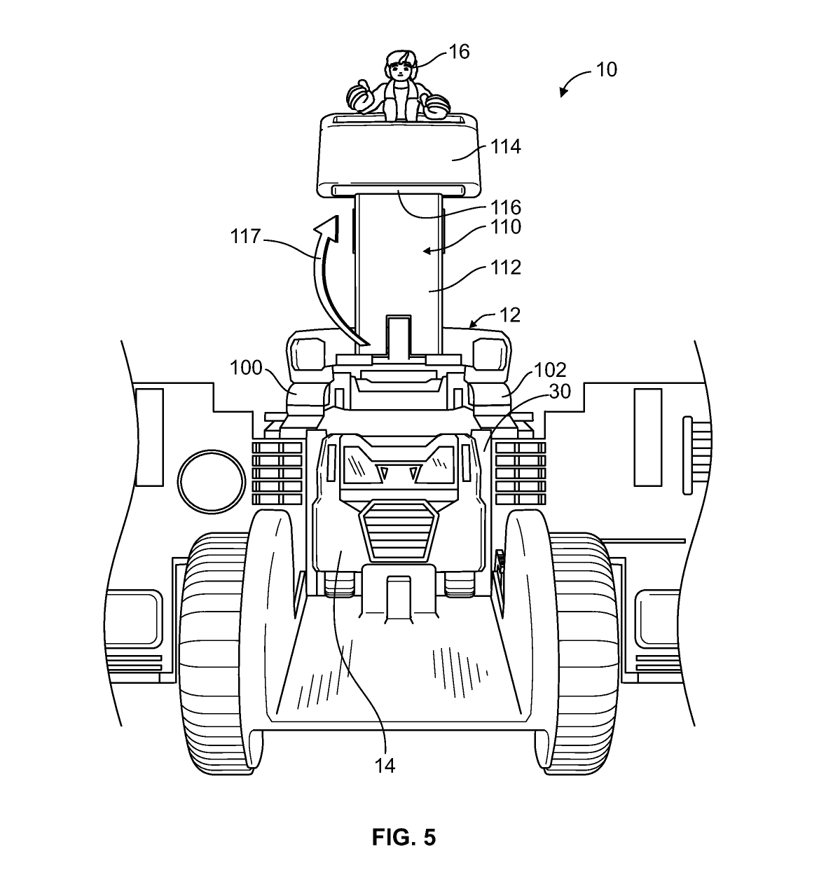

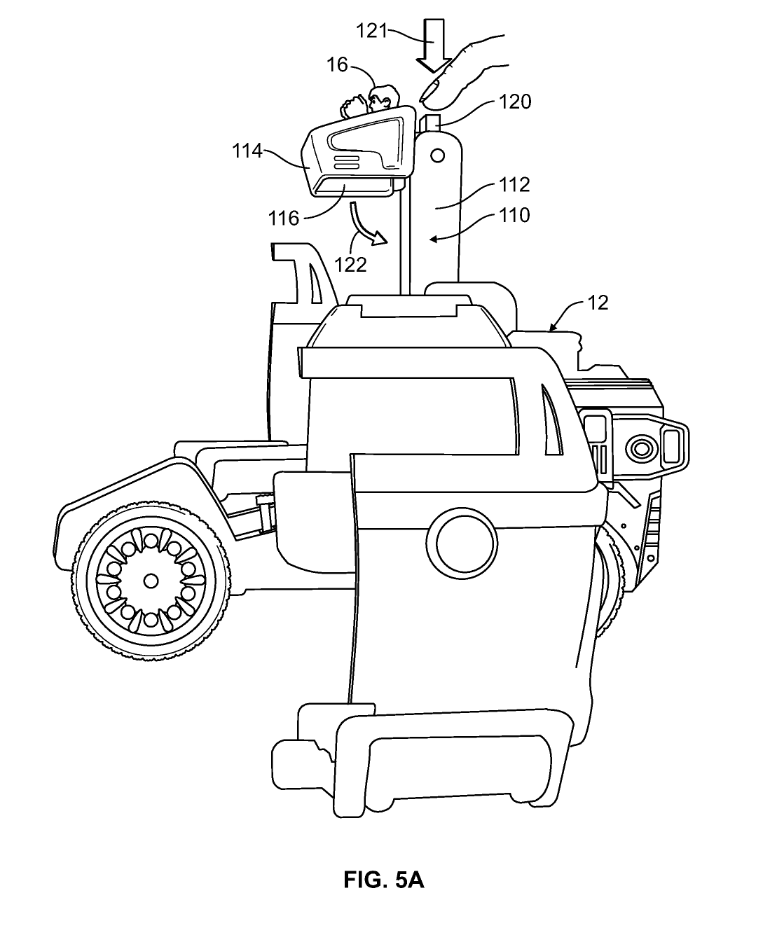

As mentioned, the first actuator 58 is both a latch to allow the sidewalls to be released and rotated, and a switch. The switch may cause lights 100, 102, FIG. 3, near the top of the large vehicle to flash and a speaker 104, FIG. 1, mounted in the left internal wall 66 to emit alarm sounds. Beneath the floor 62 of the storage compartment 30 is a small compartment (not shown) for an electronic controller, wires and batteries to control and power the lights and the speaker. A liftible ladder 110, FIGS. 5-7, is located at the top of the large vehicle 12 and includes a base section 112 and a platform 114, the platform having a trap door 116 functioning as the platform's floor. When the operator lifts or pivots the ladder from a lowered position, as shown in FIG. 4, to a raised position, as shown in FIG. 5, and indicated by an arrow 117, the platform 114 rotates such that the trap door 116 remains generally horizontal or parallel to the surface on which the toy apparatus 10 is placed. The act of raising the ladder 110 may also cause the lights 100, 102 to flash and the speaker 104 to emit alarm sounds.

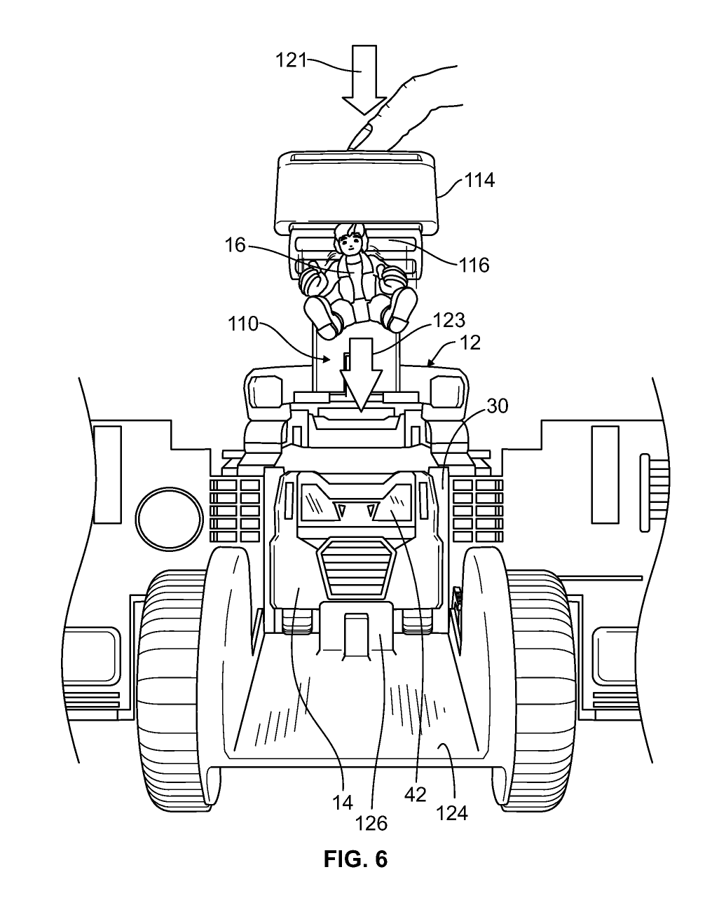

Depressing another or second actuator 120, FIG. 5A, located on the ladder 110 and indicated by an arrow 121, causes the spring loaded trap door 116, FIG. 6, to open, as indicated by an arrow 122, and another switch, part of the second actuator, cause the lights to flash and the speaker to emit alarm sounds. Enhancing the play valve of the toy apparatus 10, the operator may place the figurine 16 on the platform 114 such that the figurine 16 falls into the small vehicle 14 in the storage compartment 30 when the trap door 116 is opened, as depicted in FIGS. 6 and 7, and indicated by an arrow 123.

The large vehicle 12 includes a front ramp 124, FIGS. 6-8, extending from the storage compartment 30 for allowing the small vehicle 14 to be launched. However, separating the front ramp 124 from the storage compartment is a movable barrier plate 126 located to retain the small vehicle 14 in the storage compartment 30. Depressing a third actuator, in form of spring-biased lever 130, FIG. 8, located alongside the front ramp, as indicated by an arrow 131, lowers the barrier plate 126, as indicated by arrow 132. Depressing the lever 130 also tilts a hinged floor panel 134 of the storage compartment forward causing the small vehicle 14 to be launched by rolling down the front ramp 124, as indicated by arrows 136, 138. The lever 130 also acts as a switch to activate the lights and cause alarm sounds to be emanated. Thus, operating the third actuator 130 also enhances play value of the toy system just as operation of the first and second actuators 58, 120 created different play experiences for the toy operator.

In the alternative, other designs for the large vehicle may be used and even other types of structures. For example, instead of using the RESCUE BOTS brand as a topic for the vehicles, a STAR WARS motif may be used so that the vehicles are space ships and the figurine is a STAR WARS figure. Alternatively, the large and small structures may be a building and a vehicle respectively, or a building and a weapon, or a vehicle and a weapon, or any other combination. Also in the alternative, more or less lights may be mounted to the large vehicle/structure and a variety of different sounds may be programmed into the electronics. Furthermore, when in the playset mode the sidewalls may include more or less shelves and/or seats and/or screens, or may include other features or design motifs, such as to simulate a STAR WARS fighter base. When the sidewalls are in the closed position, the small vehicle may be completely hidden or partially so, as a function of the particular design of the large vehicle. The large vehicle may be designed without the ladder or the platform with the trap door; other design features may be used instead, such a robot lifting crane in the STAR WARS motif.

Also in the alternative, the small toy vehicle 14 may be launched from the large toy vehicle whether the ladder is raised or lowered and the ladder may be operated between lowered and raised positions when the side structures are in the opened or the closed position. The ladder may also be rotatable about a vertical axis and may be extendable. The small toy vehicle may be loaded into the storage compartment along the rear ramp whether the ladder is raised or lowered and whether the sidewalls are in the open or the closed position. The side structures may be constructed to open separately or, as shown, together. Depressing each of the actuators may cause the same or different sounds to be emitted and the light illumination pattern may be the same or may be different as a function of which actuator is depressed. Additional accessories may be used with the vehicles for enhanced play value, such as a movable second ladder mounted to the driver's cabin 40 of the large vehicle 12, for example, or to the rear ramp 44, or to the ladder 110 atop the large vehicle, or to the right sidewall 52, or even to the driver's cabin 42 of the small toy vehicle 14.

The small toy vehicle 14 is scaled to fit within the storage compartment 30 of the large toy vehicle 12 and may be manipulated alone or with the large toy vehicle. The small toy vehicle 14 is articulated so as to pivot about an axis 140, FIGS. 10 and 13, such that the small toy vehicle may be transformed from a vehicle configuration to a robot configuration, as shown in sequence in FIGS. 9-11. The small toy vehicle 14 is shown in a vehicle configuration in FIG. 9, but when a front section 142 of the small toy vehicle is rotated clockwise about 90° about the axis 140, as indicated by an arrow 143 in FIG. 10, the small toy vehicle is transformed to the robot 144, FIG. 11. The robot 144 is configured like the robot marketed under the OPTIMUS PRIME brand. To transform the robot back to the small toy vehicle 14, as shown in sequence in FIGS. 12-14, a top section 146, FIG. 13, of the robot 144 is rotated counterclockwise about 90° around the axis 140, as indicated by an arrow 145 shown in FIG. 13, to achieve the configuration of the small toy vehicle 14 shown in FIG. 14.

The driver's cabin 42 of the small vehicle 12 is scaled to receive the figurine 16 or a duplicate or similar figurine in a seated position, as shown in FIG. 8. The platform 114, FIGS. 5 and 5A is also scaled to receive the figurine 16. The small toy vehicle 14 may also have alternative design motifs and may be powered, as may the large toy vehicle 12. The figurine 16, FIG. 1, may be articulated around an axis 150 located at the hips, an axis 152 located at the shoulders and/or an axis 154 at the neck. In the alternative, the figurine may not have any articulation or may be articulated around more or less axes than those already described for the figurine 16. A further alternative may include more figurines, for example, one for the driver's cabin 40 of the large toy vehicle, another for the ladder platform 114 to be dropped into the driver's cabin 42 of the small toy vehicle and a third or more figurines for the playset. The figurine 16 is designed to have hands 160, 162, FIG. 1, that may grip portions of the large and small toy vehicles or accessories such as the movable ladder or a steering wheel.

In operation of the toy system 10, an operator may load the small toy vehicle 14 into the storage compartment 30 of the large toy vehicle 12 by dropping the rear ramp, and, after closing the ramp, move the large toy vehicle on the play surface 48. The large and small toy vehicles may also be rolled on the play surface when they are apart. Another play mode starts by the operator depressing the first actuator 58 to open the sidewalls 50, 52 from the closed position to the opened playset position. In the opened playset position, the operator may move one or more figurines around the left and right sidewalls and interact with features on the sidewalls, such as the seats 82, 96, for example. In a yet another play mode, the operator may raise the ladder and place the figurine on the platform. Upon depression of the second actuator, the figurine is allowed to drop from the platform to the driver's cabin of the small toy vehicle. A still further play mode occurs when the operator depresses the third actuator to lower the barrier plate and pivot the floor panel of the storage compartment to urge the small toy vehicle to roll down the front ramp and move away from the large toy vehicle.

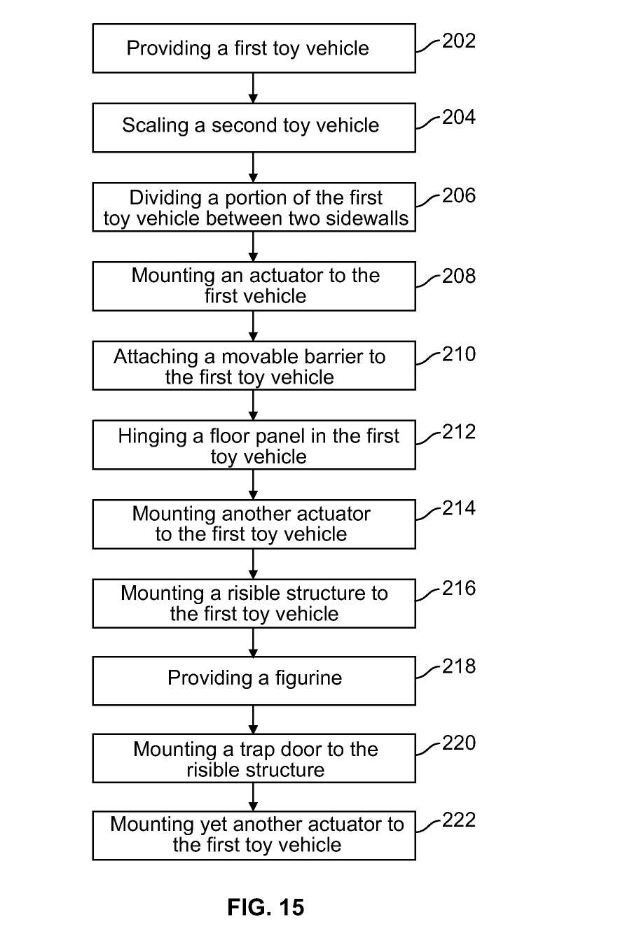

A method for manufacturing the toy system 200, FIG. 15, with two toy vehicles includes the steps of providing a first toy vehicle 202 having a storage compartment and front and rear ramps, scaling a second toy vehicle 204 to enable the second toy vehicle to be received and stored in the storage compartment of the first toy vehicle by using the rear ramp and launched from the first toy vehicle by using the front ramp, dividing a portion of the first toy vehicle 206 between two sidewalls, the sidewalls being movable between a closed position and an opened position, mounting an actuator to the first toy vehicle 208 to cause the side structures to move from the closed position to the opened position, attaching a movable barrier to the first toy vehicle 210 to enable the second toy vehicle to be retained, hinging a floor panel to the first toy vehicle 212 to facilitate launching of the second toy vehicle from the storage compartment and along the front ramp, mounting another actuator to the first toy vehicle 214 for raising the floor panel and lowering the movable barrier, mounting a risible structure on the first toy vehicle 216 movable between a lowered position and a raised position, providing a figurine 218 to be mounted on the risible structure, mounting a trap door on the risible structure 220 movable between closed and opened positions to enable the mounted figurine to drop from the trap door to the second toy vehicle, and mounting yet another actuator to the first toy vehicle 222 to cause the trap door to move to the opened position.

An important feature of the toy system is that the two toy vehicles and the figurine provide for many play modes to enhance the imagination of young children who operate the toy system. The structures described above are simple, compact, robust and relatively inexpensive while providing an apparatus having excellent play value. The toy system is also easy to use and operate.

From the foregoing, it can be seen that there has been provided features for an improved toy system with enhanced play value and a method of manufacturing the toy structures of the toy system. While a particular embodiment of the present invention has been shown and described in detail, and alternatives have been suggested, it will be obvious to those skilled in the art that many changes and modifications may be made without departing from the invention in its broader aspects. Therefore, the aim here is to cover all such changes and modifications as fall within the true spirit and scope of the invention as expressed in the appended claims. The matters set forth in the foregoing description and accompanying drawings are offered by way of illustrations only and not as claim limitations. The actual scope of the invention is to be defined by the subsequent claims when viewed in their proper perspective based on the prior art.

What is claimed is:

1. A toy system having two play structures comprising:
a first toy structure having a storage compartment, front and rear ramps communicating with the storage compartment, and first and second sidewalls being movable along vertical axes between a closed position covering the storage compartment and an opened position exposing the storage compartment; and
a second toy structure receivable in the storage compartment along the rear ramp to enable the second toy structure to be stored and transported in the storage compartment of the first toy structure when the first and second sidewalls are in the closed position and to be launched from the first toy structure along the front ramp when the first and second sidewalls are in the opened position.

2. The toy system of claim 1, wherein:
the first toy structure includes an actuator for moving the first and second sidewalls through about 90° from the closed position to the opened position.

3. The toy system of claim 1, wherein:
the first toy structure includes a risible structure having a platform at an extended end, the risible structure being movable from a lowered position to a raised position.

4. The toy system of claim 1, including:
a figurine movable between the first toy structure and the second toy structure.

5. The toy system of claim 1, wherein:
the first toy structure includes a barrier for retaining the second toy structure in the storage compartment.

6. The toy system of claim 1, wherein:
the first toy structure includes another actuator for launching the second toy structure from the storage compartment.

7. The toy system of claim 1, wherein:
the first toy structure includes lights and a sound generator.

8. The toy system of claim 1, wherein:
the second toy structure is articulated to enable the second toy structure to be transformed into a robot.

9. The toy system of claim 1, wherein:
the first toy structure includes an actuator for moving the first and second sidewalls through about 90° from the closed position to the opened position; and
the first toy structure includes a risible structure having a platform at an extended end, the risible structure being movable from a lowered position to a raised position.

10. The toy system of claim 9, including:
a figurine movable between the first toy structure and the second toy structure.

11. The toy system of claim 10, wherein:
the first toy structure includes a barrier for retaining the second toy structure in the storage compartment.

12. The toy system of claim 11, wherein:
the first toy structure includes another actuator for launching the second toy structure from the storage compartment.

13. The toy system of claim 12, wherein:
the second toy structure is articulated to enable the second toy structure to be transformed into a robot.

14. A toy system having two toy vehicles comprising:
a first toy vehicle having a storage compartment, front and rear ramps communicating with the storage compartment, and first and second sidewalls being movable along vertical axes between a closed position covering the storage compartment and an opened position exposing the storage compartment and a first actuator to enable the first and second sidewalls to move from the closed position to the opened position;
a second toy vehicle receivable in the storage compartment when the rear ramp is opened to enable the second toy vehicle to be stored and transported in the storage compartment of the first toy vehicle when the first and second sidewalls are in the closed position and to be launched from the first toy vehicle along the front ramp when the first and second sidewalls are in the opened position.

15. The toy system of claim 14, wherein:
the first toy vehicle includes a risible structure having a platform at an extended end, the platform having a trap door floor, and the risible structure being movable from a lowered position to a raised position; and
a second actuator for opening the trap door.

16. The toy system of claim 15, wherein:
the first toy vehicle includes a barrier for retaining the second toy structure in the storage compartment and a hinged panel in the storage compartment to enable the second vehicle to be launched; and
the first toy vehicle includes a third actuator for lowering the barrier and raising the hinged panel.

17. The toy system of claim 16, including:
a figurine movable from the risible structure of the first toy vehicle to the second toy vehicle; and
the first toy vehicle includes lights and a sound generator.

18. A method for manufacturing a toy system with two toy vehicles comprising the steps of:
providing a first toy vehicle having a storage compartment and front and rear ramps;
scaling a second toy vehicle to enable the second toy vehicle to be received and stored in the storage compartment of the first toy vehicle by using the rear ramp and launched from the first toy vehicle by using the front ramp;
dividing a portion of the first toy vehicle between two sidewalls, the sidewalls being movable between a closed position and an opened position; and
mounting an actuator to the first toy vehicle to cause the side structures to move from the closed position to the opened position.

19. The method of claim 18, including the step of:
attaching a movable barrier to the first toy vehicle to enable the second toy vehicle to be restrained;
hinging a floor panel to the large vehicle to facilitate launching the second toy vehicle from the storage compartment and down the front ramp; and
mounting another actuator to the first toy vehicle for raising the floor panel and lowering the movable barrier.

20. The method of claim 19, including the steps of:
mounting a risible structure on the first toy vehicle movable between a lowered position and a raised position;
providing a figurine to be mounted on the risible structure;
mounting an trap door on the risible structure movable between closed and opened positions on the risible structure to enable the mounted figurine to drop from the trap door to the second toy vehicle; and
mounting a further actuator to cause the trap door to move to the opened position.
